(19) United States
(12) Patent Application Publication
(10) Pub. No.: US 2016/0171760 A1
(43) Pub. Date: Jun. 16, 2016

(54) ELECTRONIC DEVICE AND METHOD FOR PROCESSING POINT CLOUD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: TAO TAO, Shenzhen (CN); XIN-YUAN WU, Shenzhen (CN); HENG ZHANG, Shenzhen (CN); ZONG-TAO YANG, Shenzhen (CN)

(21) Appl. No.: 14/713,985

(22) Filed: May 15, 2015

(30) Foreign Application Priority Data
Dec. 10, 2014 (CN) 201410759441.X

(51) Int. Cl. G06T 17/20; G06T 19/20

(52) U.S. Cl. CPC G06T 17/20; G06T 19/20

(57) ABSTRACT

A method for processing a point cloud includes steps of obtaining the point cloud uploaded to an electronic device, creating a mesh point cloud made of a number of triangles from the point cloud, determining a primary reference triangle from the mesh point cloud, calculating a normal vector of the primary reference triangle, calculating a normal vector of the rest of the triangles, and adjusting a direction of the normal vector of corresponding one or more of the rest of the triangles that meet an adjusting condition. The adjusting condition is an included angle between a normal vector of an adjacent triangle and the normal vector of the primary reference triangle being greater than ninety degrees.

### FIELD

The subject matter herein generally relates to point clouds, and more particularly to an electronic device and a method for processing a point cloud obtained by scanning an object.

### BACKGROUND

A point cloud is obtained by scanning an object. An image of the object can be created from the point cloud to show surfaces of the object. When there are multiple surfaces of the object scanned, the multiple surfaces may be color coded to represent different sides of the surfaces. The different sides of the surfaces may be represented by normal vectors of triangles of a mesh point cloud of the point cloud. When the surfaces are isolated from each other, it may be difficult to ensure correct color-coding of the surfaces.

### BRIEF DESCRIPTION OF THE DRAWINGS

Implementations of the present technology will now be described, by way of example only, with reference to the attached figures.

FIG. 1 is a block diagram of an embodiment of an electronic device implementing a point cloud adjustment system for processing a point cloud.

FIG. 2 is a block diagram of an embodiment of function modules of the point cloud adjustment system of FIG. 1.

FIG. 3 is a diagrammatic view of a method for creating a mesh point cloud from the point cloud.

FIGS. 4 and 5 are a flowchart diagram of an embodiment of a method for processing a point cloud.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules can be embedded in firmware such as in an erasable-programmable read-only memory (EPROM). It will be appreciated that the modules can comprise connected logic units, such as gates and flip-flops, and can comprise programmable units, such as programmable gate arrays or processors. The modules described herein can be implemented as either software and/or hardware modules and can be stored in any type of computer-readable medium or other computer storage device.

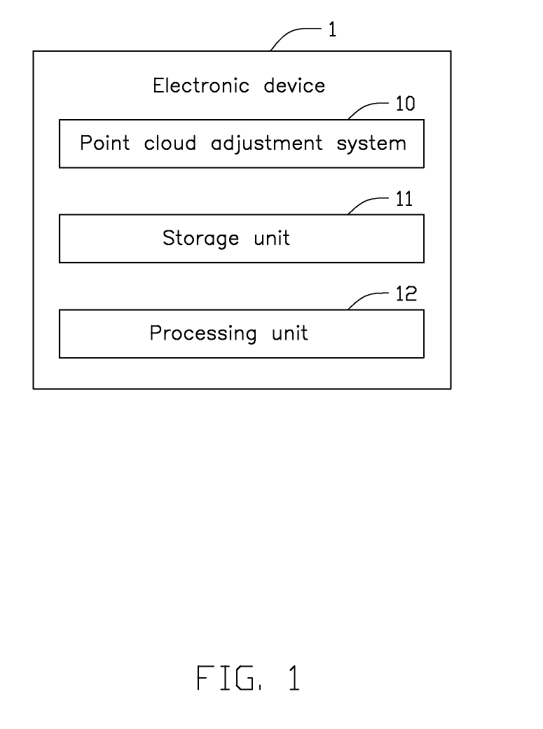

FIG. 1 illustrates an embodiment of an electronic device 1 implementing a point cloud adjustment system 10 for processing a point cloud. The point cloud can be a three-dimensional point cloud obtained by scanning a surface of an object. The point cloud can be made of a plurality of points. The electronic device 1 can further include a storage unit 11 and a processing unit 12. The storage unit 11 can store the point cloud and corresponding information of the point cloud. For example, the information of the point cloud can include three-dimensional coordinates of the points of the point cloud and a total number of the points.

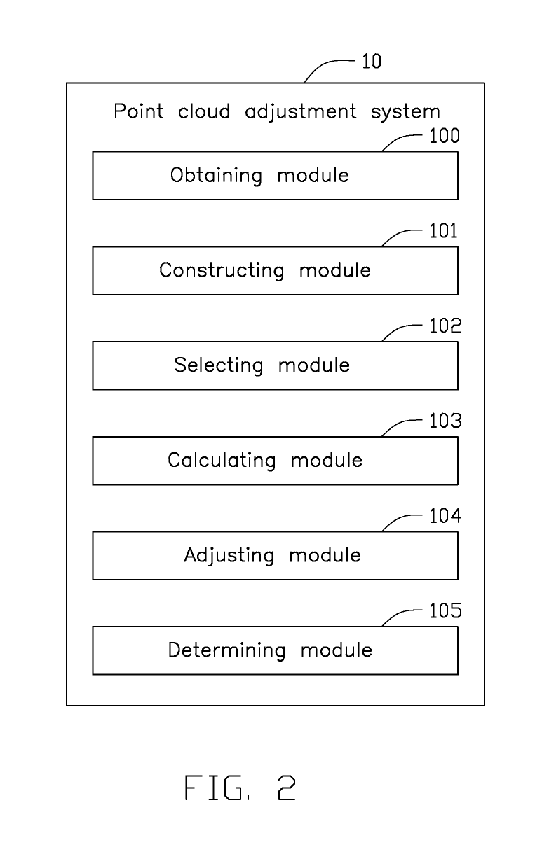

Referring to FIG. 2, the point cloud adjustment system 10 can include a plurality of modules, such as an obtaining module 100, a constructing module 101, a selecting module 102, a calculating module 103, an adjusting module 104, and a determining module 105. The modules 100-105 can include one or more software programs in the form of computerized codes stored in the storage unit 11. The computerized codes can include instructions executed by the processing unit 12 to provide functions for the modules 100-105.

The obtaining module 100 can obtain the point cloud from the storage unit 11.

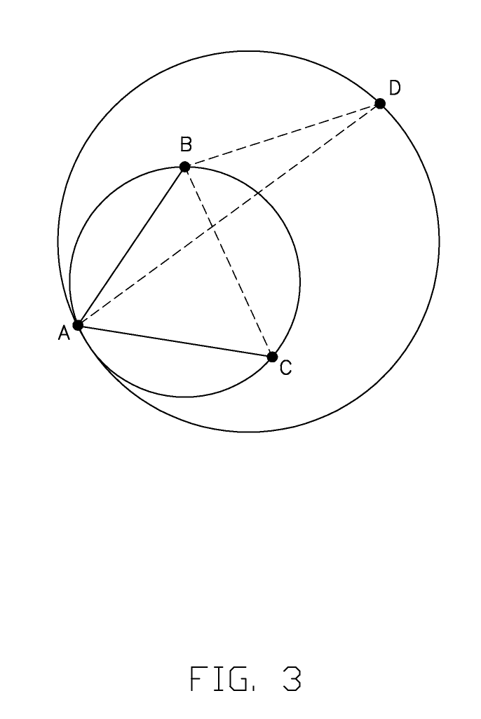

The constructing module 101 can create a mesh point cloud from the point cloud. In at least one embodiment, the constructing module 101 can create a plurality of triangles from the points of the point cloud. In at least one embodiment, the constructing module 101 can create the mesh point cloud by first calculating a bounding box of the plurality of points. The constructing module 101 can partition the bounding box into a plurality of partitions. The constructing module 101 can set a side of corresponding one or more of the partitions as a side of a triangle. The constructing module 101 can determine a third point that satisfies a triangle condition for creating a triangle with the side of the corresponding one or more partitions. In at least one embodiment, the triangle condition is defined as a circle bounding the three points of the triangle not bounding any other points of the point cloud. For example, referring to FIG. 3, the points A, B, and C satisfy the triangle condition, and the point A, B, and D do not satisfy the triangle condition. The constructing module 101 can set each side of the triangles created as a side of an adjacent triangle. The constructing module can determine a third point of each of the adjacent triangles that satisfies the triangle condition. The constructing module can set sides of newly created triangles as sides of new adjacent triangles and determine a third point of each of the new adjacent triangles, until all of the points of the point cloud are a vertex point of a corresponding triangle.

The selecting module 102 can determine a primary reference triangle of the mesh point cloud. The primary reference triangle can be determined by calculating a center coordinate point of the mesh point cloud, and calculating a center coordinate point of each of the triangles of the mesh point cloud. The primary reference triangle can be the triangle having a center coordinate point located closest to the center coordinate point of the mesh point cloud.

The calculating module 103 can calculate a normal vector of the primary reference triangle. In at least one embodiment, the vertex points of each triangle of the mesh point cloud are counted in a predetermined sequence. For example, referring to FIG. 3, a first vertex point of the triangle is the point A, a second vertex point of the triangle is the point B, and a third vertex point of the triangle is the point C. The normal vector of the primary reference triangle can be equal to a cross product of a first segment and a second segment of the primary reference triangle. For example, the first segment is defined by the first vertex point A and the second vertex point B, and the second segment is defined by the second vertex point B and the third vertex point C.

The selecting module 102 can select a plurality of adjacent triangles of the primary reference triangle. Each adjacent triangle can share a border with the primary reference triangle. The calculating module 103 can calculate a normal vector of each of the adjacent triangles according to the predetermined sequence of vertex points.

The adjusting module 104 can determine whether any of the normal vectors of the adjacent triangles meet an adjusting condition. The adjusting module 104 can adjust the normal vector of the corresponding adjacent triangles that meet the adjusting condition, and then set each of the adjacent triangles as newly set primary reference triangles. The selecting module 102 can determine new adjacent triangles of each of the newly set primary reference triangles, and the calculating module 103 can calculate a normal vector of each of the new adjacent triangles. The adjusting module 104 can determine whether any of the normal vectors of the new adjacent triangles meet the adjusting condition, and then adjust the normal vectors of the new adjacent triangles that meet the adjusting condition. In at least one embodiment, the adjusting condition is defined as an included angle between the normal vector of the corresponding adjacent triangle and the normal vector of the corresponding primary reference triangle being greater than ninety degrees. The normal vector can be adjusted by reversing the predetermined sequence of the vertex points, and the adjusted normal vector is equal to a cross product of a first segment and a second segment as defined by the reversed predetermined sequence of vertex points. A process of calculating the normal vectors of the new adjacent triangles, adjusting corresponding normal vectors of the new adjacent triangles, setting the new adjacent triangles as newly set primary reference triangles, and determining new adjacent triangles of the newly set primary reference triangles can be repeated until no more new adjacent triangles of the newly set primary reference triangles can be determined. Thus, an image created from the point cloud can be color-coded correctly do show different sides of the object.

The determining module 105 can determine whether there is one or more other triangles not adjacent to the newly set primary reference triangles. When there is one or more other triangles, the selecting module 102 can determine a secondary reference triangle of the rest of the triangles. In at least one embodiment, the secondary reference triangle is determined as the triangle of the one or more other triangles having a center coordinate point located closest to the center coordinate point of the mesh point cloud. The calculating module 103 can calculate a normal vector of the secondary reference triangle. The adjusting module 104 can determine whether the normal vector of the secondary reference triangle meets the adjusting condition in relation to the normal vector of the primary reference triangle, and adjust the normal vector of the secondary reference triangle if the normal vector meets the adjusting condition. The selecting module 102 can determine adjacent triangles of the secondary reference triangle, the calculating module 103 can calculate a normal vector of each of the adjacent triangles, and the adjusting module 104 can adjust the normal vector of corresponding adjacent triangles that meet the adjusting condition in relation to the secondary reference triangle. The adjusting module 104 can set each of the adjacent triangles as newly set secondary reference triangles, and the selecting module 102 can determine new adjacent triangles of the newly set secondary reference triangles. A process of calculating the normal vectors of the new adjacent triangles of the newly set secondary reference triangles, adjusting corresponding normal vectors of the new adjacent triangles, setting the new adjacent triangles as newly set secondary reference triangles, and determining new adjacent triangles of the newly set secondary reference triangles can be repeated until no more new adjacent triangles of the newly set secondary reference triangles can be determined.

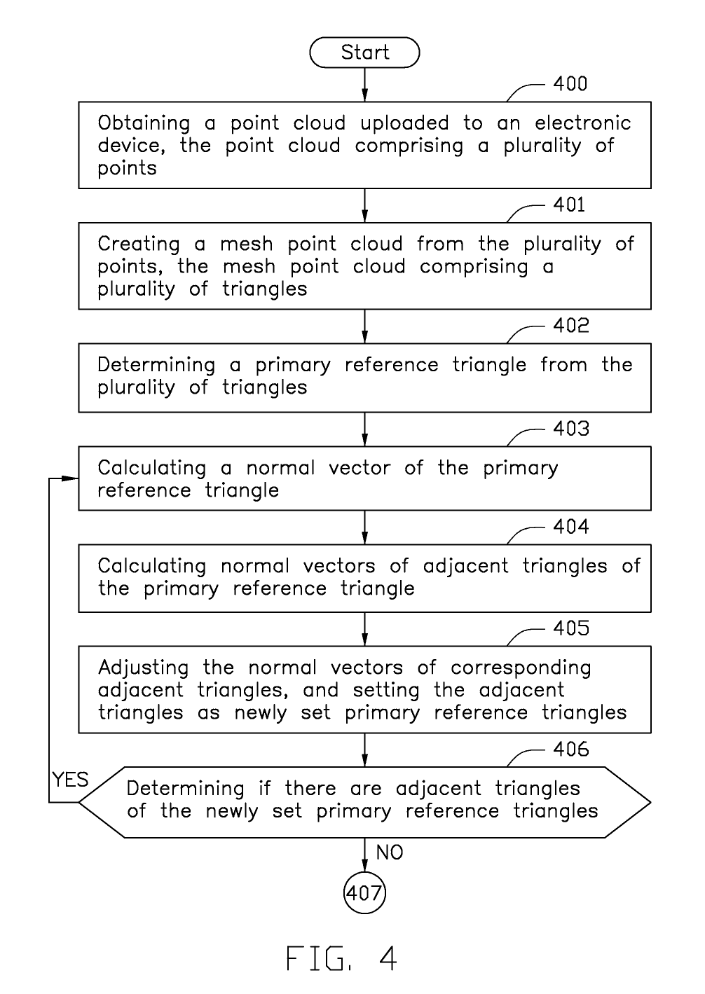

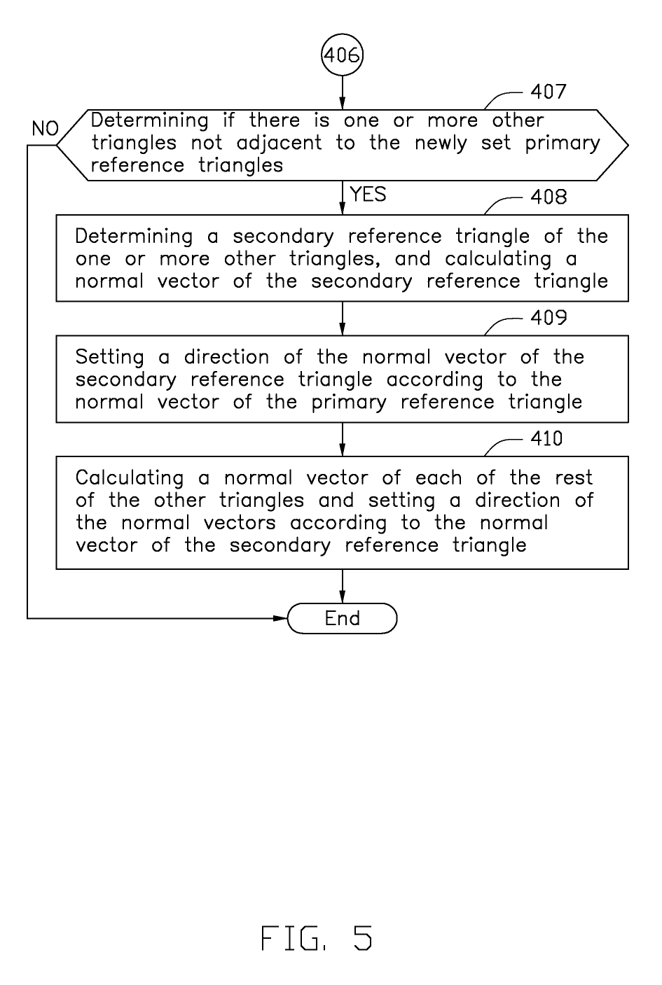

FIGS. 4-5 illustrate a flowchart of an exemplary method for processing a point cloud obtained by scanning an object. The example method is provided by way of example, as there are a variety of ways to carry out the method. The method described below can be carried out using the configurations illustrated in FIGS. 1-3, for example, and various elements of these figures are referenced in explaining the example method. Each block shown in FIGS. 4-5 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block 400.

At block 400, a point cloud uploaded to an electronic device can be obtained. The point cloud can include a plurality of points.

At block 401, a mesh point cloud can be created from the plurality of points. The mesh point cloud can be made of a plurality of triangles. The mesh point cloud can be created by first calculating a bounding box of the plurality of points. The bounding box can be partitioned into a plurality of partitions. A side of corresponding one or more of the partitions can be set as a side of a triangle. A third point that satisfies a triangle condition for creating a triangle with the side of the corresponding one or more partitions can be determined. In at least one embodiment, the triangle condition is defined as a circle bounding the three points of the triangle not bounding any other points of the point cloud. Each side of the triangles created can be set as a side of an adjacent triangle. A third point of each of the adjacent triangles that satisfies the triangle condition can be determined. Sides of newly created triangles can be set as sides of new adjacent triangles, and a third point of each of the new adjacent triangles can be determined, until all of the points of the point cloud are a vertex point of a corresponding triangle.

At block 402, a primary reference triangle from the plurality of triangles can be determined. The primary reference triangle can be determined by calculating a center coordinate point of the mesh point cloud, and calculating a center coordinate point of each of the triangles of the mesh point cloud. The primary reference triangle can be the triangle having a center coordinate point located closest to the center coordinate point of the mesh point cloud.

At block 403, a normal vector of the primary reference triangle can be calculated. In at least one embodiment, the vertex points of each triangle of the mesh point cloud are counted in a predetermined sequence. The normal vector of the primary reference triangle can be equal to a cross product of a first segment and a second segment of the primary reference triangle. For example, the first segment is defined by a first vertex point and a second vertex point of the triangle, and the second segment is defined by the second vertex point and a third vertex point of the triangle.

At block 404, normal vectors of adjacent triangles of the primary reference triangle can be calculated. Each of the adjacent triangles can share a border with the primary reference triangle.

At block 405, the normal vectors of corresponding adjacent triangles that meet an adjusting condition can be adjusted, and each of the adjacent triangles can be set as newly set primary reference triangles. In at least one embodiment, the adjusting condition is defined as an included angle between the normal vector of the corresponding adjacent triangle and the normal vector of the corresponding primary reference triangle being greater than ninety degrees. The normal vector can be adjusted by reversing the predetermined sequence of the vertex points, and the adjusted normal vector is equal to a cross product of a first segment and a second segment as defined by the reversed predetermined sequence of vertex points.

At block 406, whether there are adjacent triangles of the newly set primary reference triangles can be determined. When there are adjacent triangles of the newly set reference triangles, block 403 can be implemented. Otherwise, when there are no adjacent triangles of the newly set reference triangles, block 407 can be implemented.

At block 407, whether there is one or more other triangles not adjacent to the newly set primary reference triangles can be determined. When there is one or more other triangles, block 408 can be implemented. Otherwise, when there are no other triangles, the method ends.

At block 408, a secondary reference triangle of the one or more other triangles can be determined, and a normal vector of the secondary reference triangle can be calculated. In at least one embodiment, the secondary reference triangle is determined to be the triangle of the one or more other triangles having a center coordinate point located closest to the center coordinate point of the mesh point cloud.

At block 409, a direction of the normal vector of the secondary reference triangle can be set. In at least one embodiment, the normal vector of the secondary reference triangle is adjusted if the normal vector meets the adjusting condition in relation to the normal vector of the primary reference triangle.

At block 410, adjacent triangles of the secondary reference triangle can be determined, normal vectors of the adjacent triangles can be calculated, corresponding normal vectors of the adjacent triangles that meet the adjusting condition in relation to the secondary reference triangle can be adjusted, and the adjacent triangles can be set as newly set secondary reference triangles. A process of calculating the normal vectors of the new adjacent triangles of the newly set secondary reference triangles, adjusting corresponding normal vectors of the new adjacent triangles, setting the new adjacent triangles as newly set secondary reference triangles, and determining new adjacent triangles of the newly set secondary reference triangles can be repeated until no more new adjacent triangles of the newly set secondary reference triangles can be determined.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size and arrangement of the parts within the principles of the present disclosure up to, and including, the full extent established by the broad general meaning of the terms used in the claims.

What is claimed is:

1. A method for processing a point cloud comprising a plurality of points, the method comprising:
obtaining, by an electronic device, the point cloud uploaded thereto;
creating, by the electronic device, a mesh point cloud from the plurality of points, the mesh point cloud comprising a plurality of triangles made from the plurality of points;
determining, by the electronic device, a primary reference triangle from the plurality of triangles;
calculating, by the electronic device, a normal vector of the primary reference triangle;
calculating, by the electronic device, a normal vector of the rest of the plurality of triangles; and
adjusting, by the electronic device, a direction of the normal vector of corresponding one or more of the rest of the plurality of triangles that meet an adjusting condition.

2. The method as in claim 2, wherein a process of creating the mesh point cloud comprises:
calculating a bounding box of the plurality of points;
partitioning the bounding box into a plurality of partitions;
setting a side of corresponding one or more of the plurality of partitions as a side of a triangle;
determining a third point that satisfies a triangle condition for creating a triangle with the side of the corresponding one or more partitions;
setting each side of the triangles created from the corresponding one or more of the plurality of partitions as a side of an adjacent triangle;
determining a third point of each of the adjacent triangles that satisfies the triangle condition; and
setting sides of newly created triangles as sides of new adjacent triangles and determining a third point of each of the new adjacent triangles, until all of the points of the point cloud are a vertex point of a corresponding triangle.

3. The method as in claim 2, wherein the triangle condition is defined as a circle bounding the three points of the triangle not bounding any other points.

4. The method as in claim 3, wherein a process of determining the primary reference triangle comprises:
calculating a center coordinate point of the mesh point cloud;
calculating a center coordinate point of each triangle of the plurality of triangles; and
determining the primary reference triangle to be the triangle having the center coordinate point located closest to the center coordinate point of the mesh point cloud.

5. The method as in claim 4, wherein:
the vertex points of each of the triangles are counted in a predetermined sequence;
the normal vector of each triangle is equal to a cross product of a first segment and a second segment of the triangle;
the first segment is defined by a first vertex point and a second vertex point of the predetermined sequence; and
the second segment is defined by the second vertex point and a third vertex point of the predetermined sequence.

6. The method as in claim 5, wherein:
after the normal vector of the primary reference triangle is calculated, a plurality of adjacent triangles of the primary reference triangle is determined;
the adjacent triangles are the triangles that share a border with the primary reference triangle;
the normal vector of each of the adjacent triangles is equal to the cross product of a corresponding first segment and a corresponding second segment of the adjacent triangle according to the predetermined sequence of the vertex points;
the normal vector of corresponding adjacent triangles is adjusted if the normal vector meets the adjusting condition;
each of the adjacent triangles is set as corresponding newly set primary reference triangles, and corresponding new adjacent triangles of each of the newly set primary reference triangles are determined; and
a process of calculating the normal vectors of the new adjacent triangles, adjusting corresponding normal vectors of the new adjacent triangles, setting the new adjacent triangles as newly set primary reference triangles, and determining new adjacent triangles of the newly set primary reference triangles is repeated until no more new adjacent triangles of the newly set primary reference triangles can be determined.

7. The method as in claim 6, wherein:
the adjusting condition is defined as an included angle between the normal vector of the corresponding adjacent triangle and the normal vector of the corresponding reference triangle being greater than ninety degrees; and
the normal vectors of the adjacent triangles that meet the adjusting condition are adjusted by reversing the predetermined sequence of the vertex points, and calculating the normal vector according to the reversed predetermined sequence.

8. The method as in claim 7, wherein:
when there is one or more other triangles not adjacent to the primary reference triangles, a secondary reference triangle of the one or more other triangles is determined, the secondary reference triangle being the triangle of the one or more other triangles having a center coordinate point located closest to the center coordinate point of the mesh point cloud;
a normal vector of the secondary reference triangle is calculated;
the normal vector of the secondary reference triangle is adjusted if the normal vector meets the adjusting condition in relation to the normal vector of the primary reference triangle;
adjacent triangles of the secondary reference triangle are determined;
a normal vector of each of the adjacent triangles of the secondary reference triangle is calculated;
the normal vectors of corresponding adjacent triangles that meet the adjusting condition in relation to the secondary reference triangle are adjusted;
each of the adjacent triangles of the secondary reference triangle is set as a newly set secondary reference triangle, and corresponding new adjacent triangles of each of the newly set secondary reference triangles are determined; and
a process of calculating the normal vectors of the new adjacent triangles of the newly set secondary reference triangles, adjusting corresponding normal vectors of the new adjacent triangles, setting the new adjacent triangles as newly set secondary reference triangles, and determining new adjacent triangles of the newly set secondary reference triangles is repeated until no more new adjacent triangles of the newly set secondary reference triangles can be determined.

9. An electronic device implementing a point cloud correction system for processing a point cloud, the electronic device configured to:
obtain a point cloud uploaded to the electronic device, the point cloud comprising a plurality of points;
create a mesh point cloud from the plurality of points, the mesh point cloud comprising a plurality of triangles made from the plurality of points;
determine a primary reference triangle from the plurality of triangles;
calculate a normal vector of the primary reference triangle;
calculate a normal vector of the rest of the plurality of triangles; and
adjust a direction of the normal vector of corresponding one or more of the rest of the plurality of triangles that meet an adjusting condition.

10. The electronic device as in claim 9, wherein the electronic device comprises:
a storage unit configured to store the point cloud and corresponding information of the point cloud, and a plurality of instructions of a plurality of modules of a point cloud correction system; and
a processing unit configured to execute the plurality of instructions of the plurality of modules of the point cloud correction system.

11. The electronic device as in claim 10, wherein the plurality of modules of the point cloud correction system comprises:
an obtaining module configured to obtain the point cloud and the corresponding information of the point cloud from the storage device, the information of the point cloud comprising three-dimensional coordinates of the points of the point cloud and a total number of the points;
a constructing module configured to create the mesh point cloud;
a selecting module configured to select the primary reference triangle;
a calculating module configured to calculated the normal vector of the primary reference triangle and of the rest of the triangles; and
an adjusting module configured to adjust the normal vector of the corresponding one or more of the rest of the triangles that meet the adjusting condition.

12. The electronic device as in claim 11, wherein a process of the constructing module creating the mesh point cloud comprises:
calculating a bounding box of the plurality of points;
partitioning the bounding box into a plurality of partitions;
setting a side of corresponding one or more of the plurality of partitions as a side of a triangle;
determining a third point that satisfies a triangle condition for creating a triangle with the side of the corresponding one or more partitions;
setting each side of the triangles created from the corresponding one or more of the plurality of partitions as a side of an adjacent triangle;
determining a third point of each of the adjacent triangles that satisfies the triangle condition; and
setting sides of newly created triangles as sides of new adjacent triangles and determining a third point of each of the new adjacent triangles, until all of the points of the point cloud are a vertex point of a corresponding triangle.

13. The electronic device as in claim 12, wherein the triangle condition is defined as a circle bounding the three points of the triangle not bounding any other points.

14. The electronic device as in claim 12, wherein a process of the selecting module determining the primary reference triangle comprises:
calculating a center coordinate point of the mesh point cloud;
calculating a center coordinate point of each triangle of the plurality of triangles; and
determining the primary reference triangle to be the triangle having the center coordinate point located closest to the center coordinate point of the mesh point cloud.

15. The electronic device as in claim 14, wherein:
the vertex points of each of the triangles are counted in a predetermined sequence;
the normal vector of each triangle is equal to a cross product of a first segment and a second segment of the triangle;
the first segment is defined by a first vertex point and a second vertex point of the predetermined sequence; and
the second segment is defined by the second vertex point and a third vertex point of the predetermined sequence.

16. The electronic device as in claim 15, wherein:
after the normal vector of the primary reference triangle is calculated, the selecting module determines a plurality of adjacent triangles of the primary reference triangle;
the adjacent triangles are the triangles that share a border with the primary reference triangle;
the normal vector of each of the adjacent triangles is equal to the cross product of a corresponding first segment and a corresponding second segment of the adjacent triangle according to the predetermined sequence of the vertex points;
the adjusting module adjusts the normal vector of corresponding adjacent triangles if the normal vector meets the adjusting condition;
the adjusting module sets each of the adjacent triangles as corresponding newly set primary reference triangles, and the selecting module determines corresponding new adjacent triangles of each of the newly set reference triangles; and
a process of calculating the normal vectors of the new adjacent triangles, adjusting corresponding normal vectors of the new adjacent triangles, setting the new adjacent triangles as newly set primary reference triangles, and determining new adjacent triangles of the newly set primary reference triangles is repeated until no more new adjacent triangles of the newly set primary reference triangles can be determined.

17. The electronic device as in claim 16, wherein:
the adjusting condition is defined as an included angle between the normal vector of the corresponding adjacent triangle and the normal vector of the corresponding reference triangle being greater than ninety degrees; and
the normal vectors of the adjacent triangles that meet the adjusting condition are adjusted by reversing the predetermined sequence of the vertex points, and calculating the normal vector according to the reversed predetermined sequence.

18. The electronic device as in claim 17, wherein:
the plurality of modules of the point cloud correction system further comprises a determining module configured to determine whether there is one or more other triangles not adjacent to the newly set primary reference triangles;
when there is one or more other triangles not adjacent to the newly set primary reference triangles, the selecting module determines a secondary reference triangle of the one or more other triangles, the secondary reference triangle being the triangle of the one or more other triangles having a center coordinate point located closest to the center coordinate point of the mesh point cloud;
the calculating module calculates a normal vector of the secondary reference triangle;
the adjusting module adjusts the normal vector of the secondary reference triangle if the normal vector meets the adjusting condition in relation to the normal vector of the primary reference triangle;
the selecting module determines adjacent triangles of the secondary reference triangle;
the calculating module calculates a normal vector of each of the adjacent triangles of the secondary reference triangle;
the adjusting module adjusts the normal vectors of the corresponding adjacent triangles that meet the adjusting condition in relation to the secondary reference triangle;
the adjusting module sets each of the adjacent triangles as newly set secondary reference triangles, and determines new adjacent triangles of the newly set secondary reference triangles; and
a process of calculating the normal vectors of the new adjacent triangles of the newly set secondary reference triangles, adjusting corresponding normal vectors of the new adjacent triangles, setting the new adjacent triangles as newly set secondary reference triangles, and determining new adjacent triangles of the newly set secondary reference triangles is repeated until no more new adjacent triangles of the newly set secondary reference triangles can be determined.
